(19) United States
(12) Patent Application Publication
(10) Pub. No.: US 2013/0221078 A1
(43) Pub. Date: Aug. 29, 2013

(54) Wrapping Material and Method Of Manufacturing The Same

(71) Applicant: McNair Law Firm, (US)

(72) Inventor: Stan Skelton, Greenville, SC (US)

(73) Assignee: McNair Law Firm, Greenville, SC (US)

(21) Appl. No.: 13/775,443

(22) Filed: Feb. 25, 2013

Related U.S. Application Data
(60) Provisional application No. 61/602,730, filed on Feb. 24, 2012.

(51) Int. Cl. B65D 65/14; B31D 1/00

(52) U.S. Cl. CPC B65D 65/14; B31D 1/00
USPC 229/87.01; 493/335; 493/456

(57) ABSTRACT

The invention relates generally to a method and material for wrapping items using separate wrapping portions of a predetermined length that are attached and released at their ends using a S-shaped interlock. The S-shaped interlock uses a repositionable multi-layered adhesive disposed at a single lateral end of each wrapping material to hold the wrapping portions together during manufacturing while allowing the wrapping portions to easily detach from one another at a desired point in the wrapping process. The separating of the wrapping portions exposes a repositionable multi-layered adhesive that is used to securely bond at least one wrapping portion around the circumference of the item being wrapped at the end of a wrapping cycle.

### CLAIM OF PRIORITY

This application claims the benefit of U.S. Provisional Patent Application No. 61/602,730, which was filed on Feb. 24, 2012.

### BACKGROUND OF THE INVENTION

1) Field of the Invention

The present invention relates to wrapping materials that include an interlocking system to releaseably attach separate wrapping portions at their lateral ends. The interlocking system holds the wrapping portions together during manufacture and placement of the wrapping portions on a roll but also easily releases the wrapping portions being used to wrap an item from the remainder of the roll of wrapping portions.

2) Description of Related Art

Wrapping materials that use interlocking systems, such as the ones described in U.S. Pat. Nos. 6,787,209 and 7,541,080 are generally known in the art. These interlocking systems described in these patents releaseably attach two wrapping portions, each of which have an adhesive layer disposed at both lateral ends of the wrapping portion. More specifically, each wrapping portion includes a first lateral end upon which a low adhesive releasable layer is disposed and a second lateral end upon which a high adhesive layer is disposed. The two wrapping portions are secured together by attaching the releasable adhesive layer of a first wrapping portion to the highly adhesive layer of a second wrapping portion as described in U.S. Pat. Nos. 6,787,209 and 7,541,080.

The disadvantage of using a system that requires both lateral ends of the wrapping portions to have an adhesive layer disposed thereon is that the item being wrapped, or a portion thereof, is likely to come in contact with the lower adhesive layer and thus some of the adhesive, which is disclosed as preferably being silicone, may stick or be otherwise transferred to the item being wrapped. For illustrative purposes only, if the wrapping portions described in the prior art were used to wrap a bale of cotton, at least a portion of the cotton would contact the releasable adhesive layer. This posses two potential problems. First, the cotton could stick to the releasable adhesive layer should the releasable layer possess a sufficient tackiness. Because cotton is sold by weight, any cotton that sticks to the prior art wrapping systems constitutes a lost profit. Even if the releasable adhesive did not possess a sufficient tackiness to cause the cotton to stick to the releasable layer, some of the releasable adhesive could be transferred to the cotton, thereby adversely affecting the ability to subsequently dye the cotton as is often done.

Another disadvantage with the prior art is that it uses a high adhesive in order to bond the wrapping portions and to secure the wrapping portion around the item being wrapped at the end of a wrapping cycle. The first disadvantage with using a high adhesive to bond the wrapping portions is that it leaves little room to correct for errors occurring during the manufacture and/or use of the wrapping material. As disclosed by the prior art, each wrapping portion should terminate exactly even with the end of the adhesive layer on the lateral ends of the wrapping portions and that the wrapping portions should be cut exact to ensure that the lateral ends exactly align. See U.S. Pat. No. 6,787,209, Col 4, II. 28-46. See also U.S. Pat. No. 7,541,080, Col. 4, II. 38-54. If such alignment is not initially achieved, there is no way to re-align the lateral ends and the wrapping portion cannot be used.

The second disadvantage with using a high adhesive is that once the wrapping portion is secured around the circumference of the item being wrapped, the lateral end having the high adhesive cannot be repositioned to account for any errors in wrapping the item. Moreover, the user may not reposition the lateral end for the purpose of placing identifying cards underneath the lateral end so as to keep the identifying card secured to the item in a manner that it is shielded from the elements such as rain.

Another limitation of the prior art wrapping material is that its use of a laminate to provide the adhesive qualities necessary to bond the wrapping portions to one another and/or to secure a wrapping portion around the circumference of an item to be wrapped prevents the wrapping material from be easily recycled because the laminate is made of a different materials than those from which the wrapping portions are manufactured.

Accordingly, it is an object of the present invention to provide a wrapping material that includes a repositionable differential adhesive disposed on only one lateral end of the wrapping material so that the adhesive included on the wrapping material does not contact the item being wrapped.

It is a further object to provide a wrapping material that includes repositionable differential adhesive that does not require covering or protecting while the wrapping material is on a roll but that allows the first wrapping portion to peel away from the second wrapping portion at the end of a wrapping cycle so that the second wrapping portion may be wrapped around the item to be wrapped.

It is a further object to provide a wrapping material that includes repositionable differential adhesive that the lateral ends of the wrapping material to be adjusted during the manufacture and/or use of the wrapping material.

It is a further object to provide an interlocking system to facilitate the attachment of two different wrapping portions by using a repositionable differential adhesive that allows to the two wrapping portions to be attached to one another until the end of the wrapping cycle, at which point the first wrapping portion may be completely detached from the second wrapping portion on the roll of wrapping material.

It is a further object to provide a to provide a wrapping material that may have a lateral end that may be repositioned during the wrapping cycle or at the completion of the wrapping cycle once the item has been wrapped with the wrapping material.

It is a further object to provide a wrapping material that is easily recycled.

### SUMMARY OF THE INVENTION

A wrapping material comprising a first wrapping portion and a second wrapping portion, wherein both the first and second wrapping portions have an upper surface having adhesive characteristics along the entire upper surface and a lower surface having non-adhesive characteristics; a multi-layered adhesive disposed on the lower surface of the second wrapping portion at a point that is generally adjacent to a first lateral end of the second wrapping portion, wherein the multi-layered adhesive comprises a first adhesive layer permanently bonded to the lower surface of the second wrapping portion and a second releasable adhesive layer disposed on the first adhesive layer that is permanently bonded to the first adhesive layer; an S-Shaped interlock bonding the first lateral end of the second wrapping portion to a second lateral end of the first wrapping portion so that an upper surface of the releasable layer directly contacts the second lateral end of the first wrapping portion so that the releasable adhesive layer releaseably bonds the first wrapping portion directly to the multi layered adhesive; wherein the S-Shaped interlock allows the first and second wrapping portions to detach at a predetermined point during a wrapping cycle so that at the end of the wrapping cycle the multi-layered adhesive releaseably attaches the lower surface of the second wrapping portion to the upper surface of the second wrapping portion, and where in an item is securely wrapped so that the item does not contact any adhesive from the second wrapping portion; and, wherein the first lateral end of the second wrapping portion may be repositioned with respect to the upper surface of the second wrapping portion.

In one embodiment, the lower surface of a second lateral end of the second wrapping portion is completely non-adhesive.

In one embodiment the first adhesive layer and the second releasable adhesive layer remain adhered to the second wrapping portion at the end of a wrapping cycle.

In one embodiment, the S-Shaped interlock is defined by a U-shaped fold portion wherein the first lateral end of the second wrapping portion is folded back over the second wrapping portion, a second lateral end of the first wrapping portion, where the multi-layered adhesive is disposed between the U-shaped fold portion and the second lateral end of the first wrapping portion so that the second lateral end covers the multi-layered adhesive so that the second lateral end is releaseably secured to the multi-layered adhesive.

In one embodiment the multi-adhesive layer allows the first wrapping portion to be repositioned with respect to the second wrapping portion to ensure the S-Shaped interlock is properly aligned.

In one embodiment, the first wrapping portion and the second wrapping portion each have an upper surface and a lower surface and one of the upper surface and the lower surface has adhesive characteristics along the entire length and width of the surface. Moreover, the multi-layered adhesive is disposed on the surface opposite of the surface having adhesive characteristics along the entire length and width of the surface.

In one embodiment, the second wrapping portion has a upper surface and a lower surface and the multi-layered adhesive is disposed on the lower surface so that when the wrapping cycle is complete, the multi-layered adhesive releaseably attaches the lower surface to the upper surface.

In one embodiment, the first adhesive layer and the second releasable adhesive layer remain adhered to the second wrapping portion at the end of a wrapping cycle.

In one embodiment, the first wrapping portion and the second wrapping portions have two opposing lateral ends and at least one of the two opposing lateral ends is tapered to guide the wrapping portions into a wrapping machine.

In one embodiment, the wrapping material includes a metalized tag carried by an upper surface of one of the first wrapping portion and the second wrapping portion to instruct a wrapping machine when to cause a dispensing roll to dispense the second wrapping portion and when to cease dispensing the second wrapping portion.

A method of manufacturing a wrapping material comprises the steps of cutting a first wrapping portion and a second wrapping portion; creating a U-shaped fold by folding a lateral end of said second wrapping portion back over the remainder of the second wrapping portion; creating a multi-layered adhesive by applying a first adhesive layer to a portion of said lateral end of said second wrapping portion and applying a second releasable adhesive layer on top of said first adhesive layer; creating a S-Shaped interlock by placing a lateral end of said first wrapping portion over the U-shaped fold so that said first wrapping portion covers the multi-layered adhesive and releaseably attaching said first wrapping portion to said multi-layered adhesive.

In one embodiment the method of manufacturing a wrapping material further comprises the step of providing one of the upper surface and lower surface of the wrapping portion with adhesive characteristics along the entire surface.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows perspective view of the wrapping material in accordance with an embodiment of the invention;

FIG. 2 shows a perspective view of the interlocking system in accordance with an embodiment of the invention;

FIGS. 3-5 show side elevation views of adhesives and interlocking system;

FIGS. 6-9 illustrate the steps of wrapping an item in accordance with an embodiment of the present invention;

FIG. 10 shows a cross-section view of the wrapping material in accordance with an embodiment of the invention;

FIG. 11 shows a top plan view of the wrapping material in accordance with an embodiment of the invention; and

FIG. 12 shows a top plan view of the wrapping material in accordance with an embodiment of the invention;

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail.

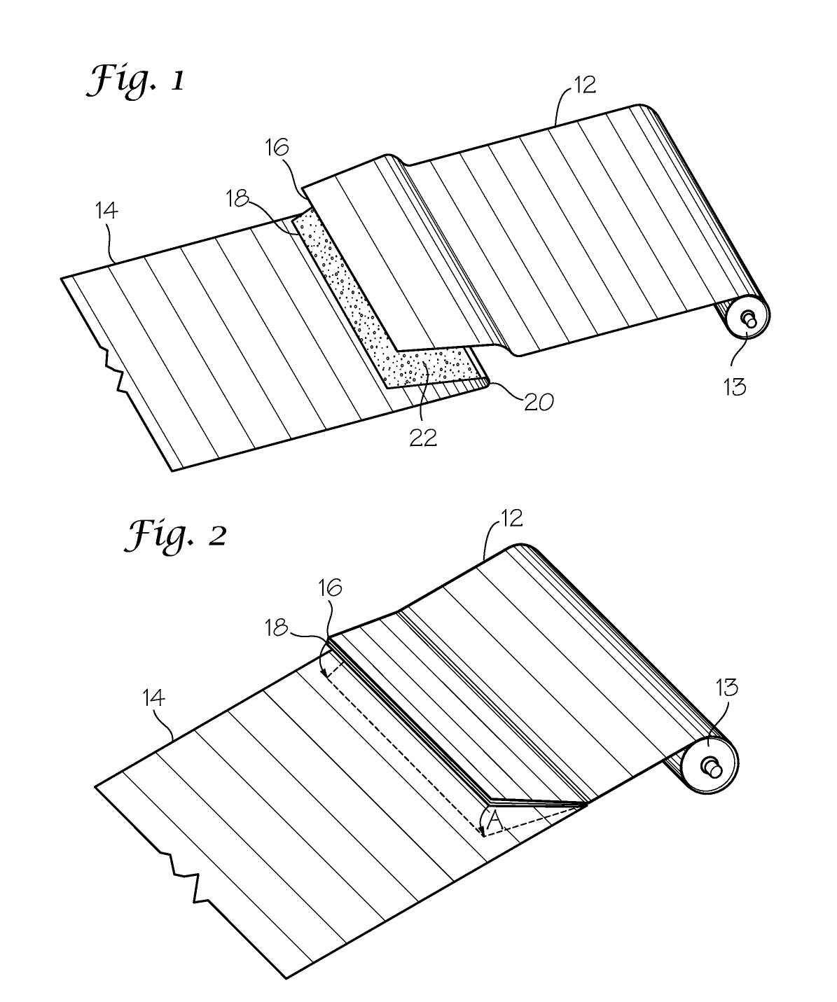

FIG. 1 is a perspective illustration of the wrapping material in accordance with an embodiment of the present invention. The wrapping material 10, being prepared in FIGS. 1-2, includes at least two wrapping portions 12 and 14, with predetermined lengths. In at least one embodiment, each wrapping portion 12 and 14 has a length of approximately 69 feet and a width of approximately one hundred and four inches. The wrapping material 10 can be made from polyolefins, such as polyethylene, or other suitable polymeric material that is approximately 40 to 120 microns thick and 50 to 400 centimeters in width. In at least one embodiment, each wrapping portion 12 and 14 has a length of approximately 21 meters and a width of approximately 264 centimeters. Additionally, the wrapping material 10 may also be clear or pigmented. In at least one embodiment, the wrapping material may have a first surface that has adhesive characteristics and a second surface that has non-adhesive characteristics. In at least one embodiment, the material's upper surface has adhesive characteristics and the lower surface has non-adhesive characteristics. In other embodiments, however, it could be that the lower surface has the adhesive characteristics and the upper surface has the non-adhesive characteristics. The material used for the wrapping material 10 is in no way limited to the materials discussed above and can include netting or other suitable wrapping material, regardless of whether such material occurs naturally or is man-made.

The length and width of each wrapping portion 12 and 14 should be enough to at least cover the circumference or perimeter of the item (not shown) to be wrapped. In at least one embodiment, the wrapping portions have a length that is longer than the circumference and/or perimeter of the item to be wrapped so that the wrapping portion may be secured to itself rather than to the item being wrapped. Accordingly, the length and width of the wrapping material can vary depending on the size and shape of the item to be wrapped and the wrapping application.

In FIG. 1, the first wrapping portion 12 is disposed upon a roll of wrapping material 13 having a plurality of releaseably attached wrapping portions (1, 2, 3 . . . n). The second wrapping portion 14 is the wrapping portion that will be used to wrap an item (not shown) in the present wrapping cycle. Each of the wrapping portions 12 and 14 include two opposing lateral ends 16 and 18. In FIG. 1, the lateral end 18 of the second wrapping portion 14 is folded back on top of itself to form a U-shaped fold 20 along the entire width of the second wrapping portion 14.

As can be seen in FIG. 1, the second wrapping portion 14 that will be used to wrap the item includes a repositionable differential adhesive area 22 that is disposed generally adjacent to the second wrapping portion's lateral end 18 so that the adhesive area extends along substantially the entire width of the second wrapping portion's lateral end 18. In another embodiment, the adhesive area 22 does not extend along the entire width of the wrapping portion's lateral end 22. By not extending the adhesive area along the entire width of the lateral end, a non-adhesive portion is left so that the lateral end may be easily repositioned with respect to the first wrapping portion 12 or with respect to the end that is opposite lateral end 18 once the wrapping portion 14 has completed a wrapping cycle. As will be discussed more fully below, the adhesive area provides sufficient adhesion to attach the two wrapping portions 12 and 14 along the U-shaped fold but allows the second wrapping portion to detach from the first wrapping portion at the end of the wrapping cycle.

As can be seen in FIG. 2, the first wrapping portion's lateral end 16 is positioned over and aligned with the second wrapping portion's lateral end 18 and adhered to the adhesive area 22. The adhesive layer 22 releaseably bonds the upper surface of the U-shaped fold 20 to the lower surface of the lateral end 16 of the first wrapping portion 12. In the shown embodiment, the lateral ends 16 and 18 of the wrapping portions are adhered so there ends are even with one another. In the shown embodiment, the lateral ends 16 and 18 terminate at the end of the adhesive layer 22. In at least one embodiment, the adhesive area 22 does not extend all the way to the lateral end 18. By not extending the adhesive area 22 to the lateral end 18, a non-adhesive portion is left so that the lateral ends 16 and 18 may be easily repositioned with respect to one another or so that lateral end 18 may be repositioned once an item has been wrapped at the completion of a wrapping cycle.

As can be seen in FIG. 2, an S-Shaped interlock is created once the lateral end 16 of the first wrapping portion is adhered to the lateral end 18 of the second wrapping portion by the adhesive area 22. As described above, this S-Shaped interlock is created by first folding lateral end 18 of the second wrapping portion in a U-shaped fold so that the lateral end 18 is folded back over a portion of the remainder of the second wrapping portion 14 and then adhering the first wrapping portion's lateral end 16 to the adhesive area 22. While FIG. 2 shows the S-Shaped interlock elevated for viewing purposes, the S-shaped interlock portion of the wrapping material allows the two wrapping portions 12 and 14 to be adhered in a fashion that they may lay substantially flush to the upper surface of the second wrapping portion 14 when the S-shaped interlock is rotated in direction A. Thus, the attached wrapping portions can be rolled on to the dispensing roll 13 while simultaneously allowing the wrapping portions to be detached from one another without the use of excess force.

In at least one embodiment, the adhesive area 22 extends to the edge of lateral end 18 and lateral end 16 is placed on adhesive area such that it terminates exactly even with or extends past the end of adhesive area 22. If either of the wrapping portions 12 and 14 are cut or positioned so that the adhesive area 22 extends past the first wrapping portion's lateral end 16, feeding problems could occur since the adhesive area 22 could potentially stick to the rollers or other metal parts. Since, however, the adhesive are 22 includes a repositionable differential adhesive, lateral ends 16 and 18 may be readjusted during manufacture and/or use of the wrapping portions 12 and 14 to ensure that lateral end 16 extends even with or past the end of adhesive area 22 closest to lateral end 18.

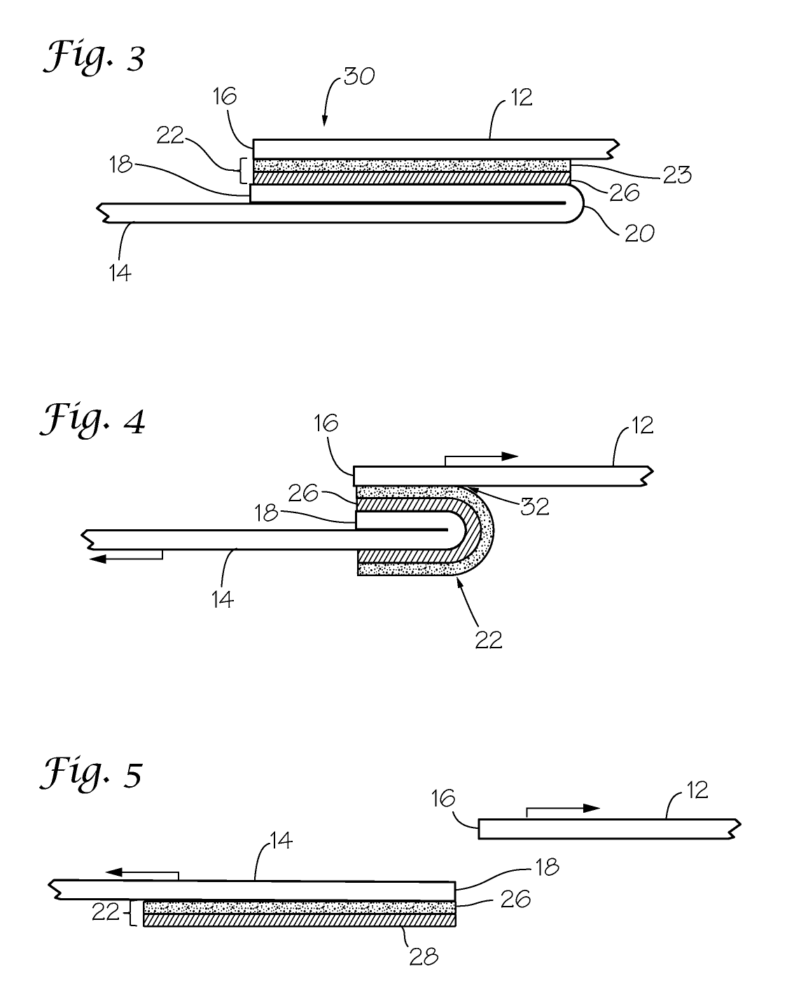

Referring now to FIGS. 3-5, the adhesive layer and the arrangement of its components may be more clearly seen. The adhesive layer 22 comprises a first highly adhesive layer 26 having a bottom surface that is permanently bonded to the second wrapping portion at a point that is generally adjacent to the lateral end 18. The highly adhesive layer 26 also has a top surface that is permanently bonded to the bottom surface of a releasable adhesive layer 28, thus permanently bonding the releasable adhesive layer 28 to the second wrapping portion 14. The highly adhesive layer 26 can be any adhesive suitable to permanently bond the releasable layer 28 to the second wrapping portion 14. In at least one embodiment, this highly adhesive later could highly adhesive layer used in the differential adhesive marketed by 3-M under the Model No. Repositionable Tape 665 and/or Repositionable Tape 9425.

The releasable adhesive layer 28 has a lower adhesive characteristic than the highly adhesive layer 26 and allows the two wrapping portions to be releaseably attached to one another. The releasable layer 28 also allows the lateral ends of the two wrapping portions to be repositioned, one or more times, with respect to one another without compromising the adhesive characteristics of the releasable adhesive layer 28. Accordingly, the releasable adhesive layer allows the user and/or manufacturer to ensure that the lateral ends 16 and 18 of the two wrapping portions are properly aligned to ensure that the S-shaped interlocking system provides maximum benefit. If, for some reason, the lateral ends are not properly aligned to ensure proper coverage of the adhesive layer and/or proper alignment upon completion of the wrapping cycle, the user may simply separate the lateral ends and reattach them until they are properly aligned. The releasable layer 28 may comprise any suitable material, including but not limited to, silicone that may be applied to the first highly adhesive layer by methods generally known in the art. In another embodiment, the releasable layer 28 may comprise the repositionable adhesive included in any repositionable differential adhesive such as the one marketed by 3-M under the Model No. Repositionable Tape 665 and/or Repositionable Tape 9425. However, other differential adhesives that are generally known in the art can be used.

As can be seen in FIGS. 3-5, the releasable layer 28 is carried on the upper surface of the U-shaped fold 20 by the highly adhesive layer 26 and attaches lateral end 18 to the first wrapping portion 12 at its lateral end 16. The boundary between the releasable adhesive layer 28 and the lower surface of first wrapping portion 12 functions as the separating line of the S-shaped interlock 30. However, prior to separation, the bond between releasable layer 28 and the lateral end 16 is sufficient to hold wrapping portions 12 and 14 together during manufacturing and placement of the wrapping material 10 on a dispensing roll 13.

FIG. 4 shows the peeling away of the releasable adhesive layer 28 from the lateral end 16 at the separating line 32. As discussed more fully below, the peeling away of the releasable adhesive layer 28 is accomplished when the dispensing roll (shown as 13 in FIGS. 1-2 and 6-9) of wrapping material stops moving and the item to be wrapped continues to move away from the dispensing roll 13. The continued movement of the item causes pressure to be exerted on the S-shaped interlocking system causing the two wrapping portions 12 and 14 to detach at the separating line 32.

FIG. 5 shows the complete separation of the S-Shaped interlock between the first wrapping portion's lateral end 16 and the second wrapping portion's releasable adhesive layer 28. The releasable adhesive layer 28 is exposed just prior to meeting the item being wrapped at the end of the wrapping cycle. Once the second wrapping portion 14 detaches from the first wrapping portion 12, the releasable adhesive layer 28 allows the second wrapping portion's lateral end 18 to complete the wrap and to secure the wrapping material to the item to be wrapped without requiring contact between the item and any portion of the adhesive layer 22. Instead, adhesive layer 22 adheres to the upper, opposite surface of wrapping material 14.

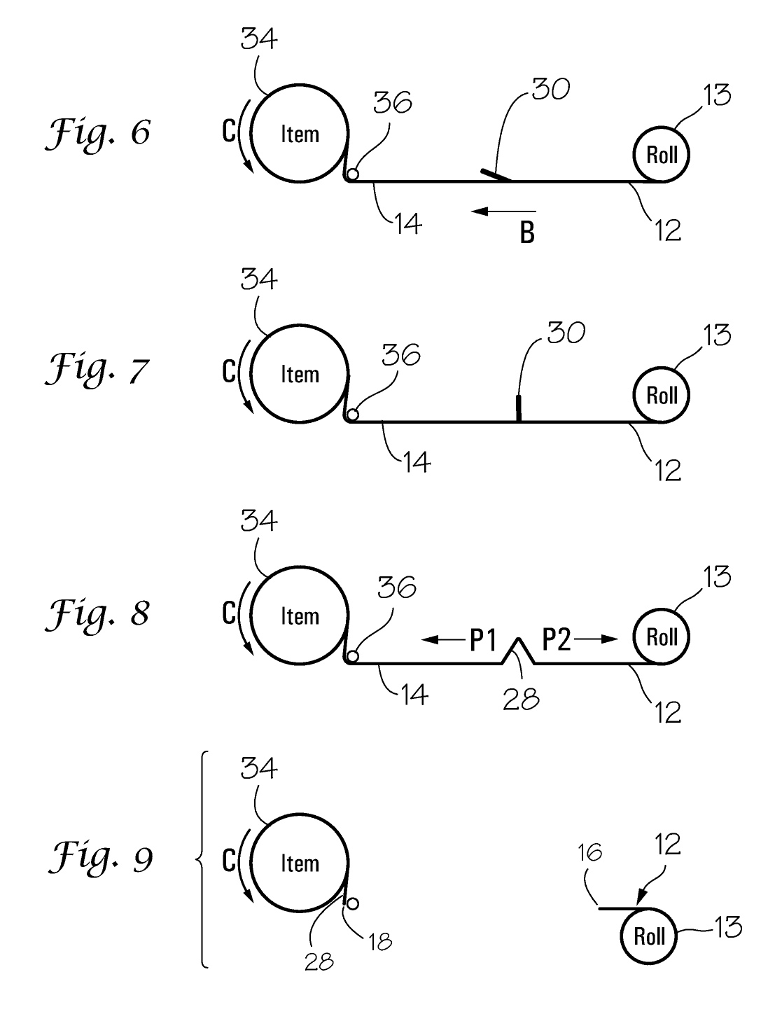

Referring now to FIGS. 6-9, a method of wrapping an item 34 using the S-shaped interlock in accordance with an embodiment of the present invention can be seen. A dispensing roll 13 holds wrapping material 10 having a plurality of releaseably attached wrapping portions (1, 2 . . . n) in which adjacent wrapping portions are attached through the S-Shaped interlock 30. By way of example only, the wrapping portions will be dispensed by an agricultural baler known in the art for baling hay, cotton or the like (e.g., existing balers and pallet wrapping machines).

As shown in FIG. 6, the wrapping portions 12 and 14 are fed from the dispensing roll 13 in direction B such that the second wrapping portion 14 is wrapped around the item 34 to be baled. The item 34 is simultaneously rotated in direction C so that it can be wrapped. In the shown embodiment, second wrapping portion 14 is fed underneath a rolling pin 36 to ensure that the item 34 is wrapped tightly and the wrapping portions 12 and 14 are generally horizontal with respect to the ground. In another embodiment, however, the dispensing roll 13 could be positioned so that the bottom of the dispensing roll is relatively level with the top of the item to be wrapped, thus alleviating the need for the rolling pin 36. After a number of turns of the wrap around the item 34 using a predetermined length of the second wrapping portion 14, the roll of wrapping material 13 will stop dispensing wrapping material while the item 34 being wrapped continues to turn in direction C. As seen in FIG. 7, the continued movement of the item 34 in direction C causes the S-Shaped interlock 30 to move to an upright position and pressure p1 and p2 to be exerted on the S-Shaped interlock 30 in opposite directions.

In FIG. 8, the wrapping dispensing roll 13 remains stationary while the item 34 being wrapped continues rotating in direction C. The increased pressure p1 and p2 exerted on the S-Shaped interlock 30 causes the S-Shaped interlock to separate and form an inverted V-shape thus beginning to expose the releasable adhesive layer 28 that is disposed on the lateral end of the second wrapping portion 14. As can be seen in FIG. 9, the continued movement of item 34 in direction C causes the S-Shaped interlock to separate so that the second wrapping portion completely peels away from the first wrapping portion 14, totally exposing the releasable adhesive layer 28. Accordingly, the releasable adhesive layer 28 is exposed at the moment it meets the item 34 being wrapped so that the wrapping cycle can be completed.

The fact that the releasable adhesive layer 28 is covered by the lateral end 16 of the first wrapping portion until the moment of adhesion to the item to be wrapped allows all the wrapping portions (1, 2 . . . n) that are rolled on the dispensing roll 13 to move smoothly between all the rollers and various parts of the baler during the wrapping process. Additionally, this prevents the releasable adhesive layer 22 from getting dirty, which would adversely affect the quality of adhesion during wrapping. Because of the advantages of the S-Shaped interlock 30, the releasable adhesive layer 22 creates a perfect adhesion to the item 34 being wrapped at the end of a wrapping cycle. The wrapping material 10 of the present invention can be fed into unmodified wrapping machinery because the portion of the wrapping material 10 that contacts the rollers is non-adhesive until the S-shaped interlock 30 is separated at the end of a wrapping cycle.

Once the wrapping cycle has been completed and the item is wrapped, the releasable adhesive layer 28 allows the user to peel the lateral end 18 away from the remainder of the wrapping material so that an identifying card may be placed under the lateral end 18 so that the identifying card is secured to the wrapped item in a manner that protects the identifying card from elements such as rain or snow. This identifying card allows the item to be identified and associated with the proper owner of the wrapped item.

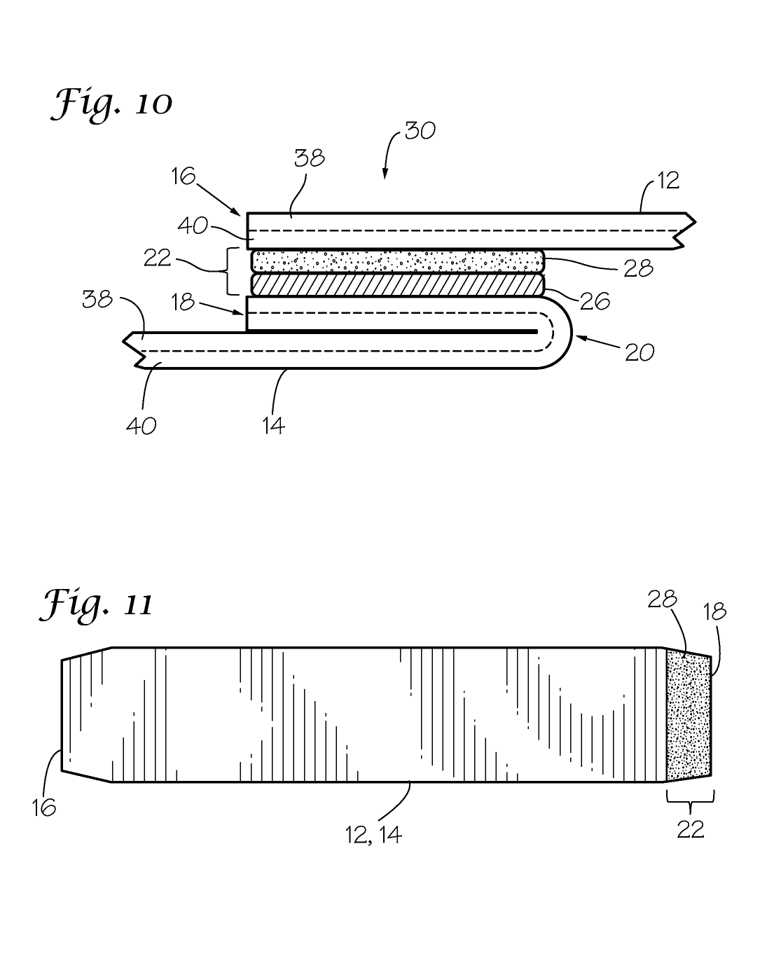

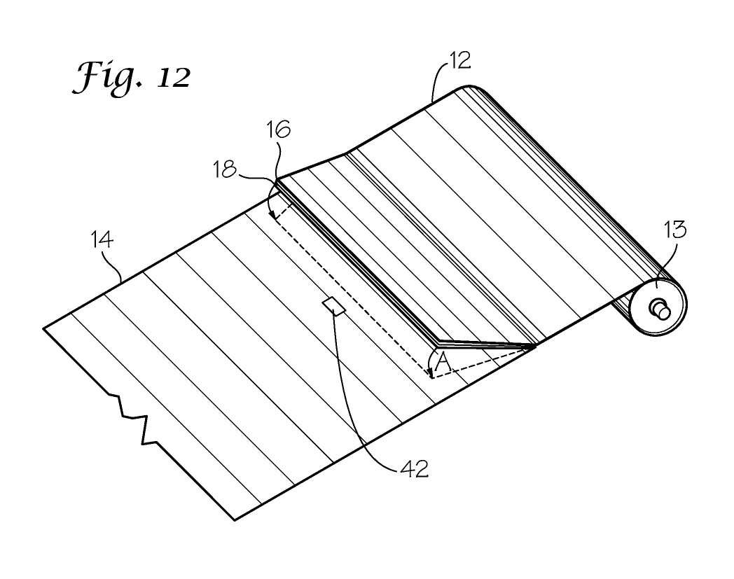

As can be seen in FIG. 10, the wrapping material 10 (i.e. each wrapping portion 1, 2 . . . n) may have an upper surface 38 having adhesive characteristics along the entire surface of said upper surface 38 and a lower surface 40 having non-adhesive characteristics along the entire surface excepting for the adhesive area 22. The lower surface 40 is the surface that is in contact with the item to be wrapped, thus ensuring that none of the wrapping material's adhesive comes in contact with the item being wrapped. The adhesive characteristics is provided by including a tackifier ingredient during the extrusion process so that the resulting film has a tackifier ingredient included in the upper surface 38 but no tackifier in the lower surface 40. In at least one embodiment a PIB tackifier is used. However, any tackifier known in the inudstry that would provide the desired adhesive characteristics can be used. By providing the upper surface 38 with adhesive characteristics, one may ensure that the wrapping material remains tightly wrapped around the item by providing additional adhesion between the releasable adhesive layer 28 and the upper surface 38 once the second wrapping portion is wrapped around the item. Depending on the length of the wrapping portions, the upper surface may also provide some adhesion between the overlapping portions of the upper surface 38 and the lower surface once the wrapping cycle is complete. This helps ensure that that item is securely wrapped.

The adhesive area 22 is disposed on the lower, non-adhesive surface 40 of the second wrapping portion 14. When the S-shaped interlock 30 is formed by placing the first wrapping portion's lateral end 16 on the upper surface of the U-shaped fold 20, the releasable layer 28 adheres to the lower non-adhesive surface 40 of the first wrapping portion 12. This ensures that the S-Shaped interlock will allow the two lateral ends to easily peel away from one another at the end of the wrapping cycle. Further, the adhesive characteristics of the upper surface 38 help that the S-Shaped interlock lays flat by causing the upper surface 38 to stick to itself when the U-shaped fold 20 is created.

Referring now to FIG. 11, in at least one embodiment, each wrapping portion 12 and 14 has tapered ends to assist with feeding the wrapping portions into the a baling and/or wrapping machine (not shown). As with other embodiments, an adhesive area 22 is disposed generally along the width of lateral end 18 of second wrapping portion. Moreover, adhesive area may be disposed along less than the entire width of lateral end and may terminate before lateral end 18. In at least one embodiment, wrapping portion 14 has a width of approximately 264 centimeters and lateral ends 16 and 18 have a width of approximately 216 centimeters. In this embodiment the S-Shaped interlock, including the adhesive area, is created in the same manner as discussed in FIGS. 1-5 and is used to wrap an item in the same manner as discussed in FIGS. 6-9.

Referring now to FIG. 12 yet another embodiment is disclosed. In this embodiment each wrapping portion 12 and 14 at least one metalized tag 42 disposed on the upper surface 38 of the wrapping portions. In at least one embodiment, the metalized tag is made of a polypropylene film having a first adhesive surface and a second surface coated with a metal foil. In this embodiment, the first highly adhesive surface is adhered to the upper surface 38 of the wrapping portion. In other embodiments, however, the metalized tag 42 could be any metalized product that could be carried by the wrapping portions in a manner that will not affect the structural integrity of the wrapping portion. In at least one embodiment two metalized tags are included on the upper surface approximately 8 inches from the side edges and approximately 8 inches from the beginning of the taper.

As is generally known in the industry, these metalized tags can be used to regulate the movement of the wrapping and/or baling machine. In one embodiment, a light source directs a beam of light across the surface of the wrapping portions, once the sensor detects a break in the beam of light, which is caused by the metalized tag's deflection of the light source, powered rollers at the dispensing roll cease to rotate and the dispensing roll ceases to feed the wrapping portions. While the dispensing roll ceases to feed wrapping portion 14, the item 34 continues to rotate so that the wrapping cycle may be completed as discussed above in FIGS. 6-9.

The wrapping material is manufactured by cutting two pieces of wrapping portions to a predetermined length and width, which will vary upon the item being wrapped. In at least one embodiment, each lateral end of the wrapping portions will be tapered to aid in guiding the wrapping portions into the wrapping machine and/or bailer.

A first high adhesive layer is then applied generally adjacent to the first lateral end of the second wrapping portion and the corresponding first lateral end of the first wrapping portion. In at least one embodiment, the high adhesive layer is added to the lower surface of the wrapping portion's lateral end. In one embodiment, the first high adhesive layer is applied so that it extends along the entire width of the wrapping portion and to the distal portion of the lateral end. In other embodiments, however, the high adhesive layer need not extend the entire width and/or to the distal portion of the lateral end.

Once the multi-layered adhesive is applied, a second low adhesive layer is applied directly to the high adhesive layer. In at least one embodiment, this is done by applying silicone to the high adhesive layer. In one embodiment, the second low adhesive layer is applied so that it covers the entire upper surface of the first high adhesive layer to ensure that the high adhesive layer does not contact a wrapping portion and/or an item being wrapped so that the lateral end will be repositionable. In alternate embodiments, however, less than all of the high adhesive layer may be covered by the second low adhesive layer.

Once the multi-layered adhesive is applied to the first lateral end of the wrapping portions, the first lateral end of the second wrapping portion is folded back over the remainder of the second wrapping portion to create a U-shaped fold, thus exposing the multi-layered adhesive. The second lateral end of the first wrapping portion, which in at least one embodiment is completely non-adhesive, is then placed over the U-shaped fold so that it covers all of the multi-layered adhesive. This creates an S-shape fold. If the first wrapping portion does not completely cover the multi-layered adhesive, it may be repositioned to ensure that all of the adhesive is covered by the first wrapping portion. The S-Shaped interlock is then created by securing the first wrapping portion to the multi-layered adhesive.

In at least one embodiment, a tackifier ingredient can be added so that when extruded, the upper surface or the lower surface of the wrapping portion will have adhesive characteristics the entire surface. In at least one embodiment, the tackifier is added so that the upper surface of the wrapping portion has adhesive characteristics along the entire surface and the multi-layered adhesive is disposed on the lower surface of the wrapping portion.

Because the wrapping material of the present invention does not use a laminate or a substrate that consists of different material than the wrapping portions like other materials in the prior art, the entirety of wrapping portions may be easily and inexpensively recycled after use without the need for removing the substrate and/or laminate layers included in the prior art.

In an alternate embodiment, metalized tags can be added to the wrapping portion to instruct the wrapping machine as to when to start the dispensing roll and when to stop it.

While a preferred embodiment of the invention has been described using specific terms, such description is for illustrative purposes only, and it is to be understood that changes and variations may be made without departing from the spirit or scope of the following claims.

What is claimed is:

1. A wrapping material comprising:
a first wrapping portion and a second wrapping portion, wherein both said first and second wrapping portions have an upper surface having adhesive characteristics along the entire upper surface and a lower surface having non-adhesive characteristics;
a multi-layered adhesive disposed on said lower surface of said second wrapping portion at a point that is generally adjacent to a first lateral end of said second wrapping portion, wherein said multi-layered adhesive comprises a first adhesive layer permanently bonded to said lower surface of said second wrapping portion and a second releasable adhesive layer disposed on said first adhesive layer that is permanently bonded to said first adhesive layer;
an S-Shaped interlock bonding said first lateral end of said second wrapping portion to a second lateral end of said first wrapping portion so that an upper surface of said releasable layer directly contacts said second lateral end of said first wrapping portion so that said releasable adhesive layer releaseably bonds said first wrapping portion directly to said multi layered adhesive;
wherein said S-Shaped interlock allows said first and second wrapping portions to detach at a predetermined point during a wrapping cycle so that at the end of the wrapping cycle said multi-layered adhesive releaseably attaches said lower surface of said second wrapping portion to said upper surface of said second wrapping portion, and where in an item is securely wrapped so that the item does not contact any adhesive from said second wrapping portion; and,
wherein said first lateral end of said second wrapping portion may be repositioned with respect to said upper surface of said second wrapping portion.

2. The wrapping material of claim 1 wherein said lower surface of a second lateral end of said second wrapping portion is completely non-adhesive.

3. The wrapping portion of claim 1 wherein said first adhesive layer and said second releasable adhesive layer remain adhered to said second wrapping portion at the end of a wrapping cycle.

4. The wrapping material of claim 1 wherein said S-Shaped interlock is defined by:
a U-shaped fold portion wherein said first lateral end of said second wrapping portion is folded back over said second wrapping portion,
a second lateral end of said first wrapping portion, and
said multi-layered adhesive being disposed between said U-shaped fold portion and said second lateral end of said first wrapping portion so that said second lateral end covers said multi-layered adhesive so that said second lateral end is releaseably secured to said multi-layered adhesive.

5. The wrapping material of claim 1 wherein said multi-adhesive layer allows said first wrapping portion to be repositioned with respect to said second wrapping portion to ensure said S-Shaped interlock is properly aligned.

6. A wrapping material comprising:
a first wrapping portion;
a second wrapping portion;
a multi-layered adhesive disposed on said second wrapping portion, wherein said multi-layered adhesive comprises a first adhesive layer having a lower surface permanently bonded to said second wrapping portion and a second releasable adhesive layer having a lower surface that is permanently bonded to an upper surface of said first adhesive layer;
an S-Shaped interlock releaseably attaching said first wrapping portion to said second wrapping portion during a wrapping cycle.

7. The wrapping material of claim 6 wherein said multi-layered adhesive is disposed at a point that is generally adjacent to a first lateral end of said second wrapping portion.

8. The wrapping material of claim 6 wherein said second wrapping portion has a first lateral end and a second lateral end, wherein said multi-layered adhesive is disposed generally adjacent said first lateral end and said second lateral end is completely non-adhesive.

9. The wrapping material of claim 6 wherein said multi-layered adhesive is disposed on a lower surface of said first lateral end and said lower surface of said second lateral end is completely non-adhesive.

10. The wrapping material of claim 6 wherein said S-Shaped interlock is defined by:
a lateral end of said second wrapping portion that is folded back over said second wrapping portion to create a U-shaped fold, and
a lateral end of said first wrapping portion placed over said U-shaped fold so that said lateral end covers said multi-layered adhesive, and is releaseably secured to said multi-layered adhesive.

11. The wrapping material of claim 10 wherein said multi-adhesive layer allows said first wrapping portion to be repositioned with respect to said second wrapping portion to ensure said lateral end of said first wrapping portion completely covers said multi-layered adhesive.

12. The wrapping material of claim 6 wherein said first wrapping portion and said second wrapping portion each have an upper surface and a lower surface and one of said upper surface and said lower surface has adhesive characteristics along the entire length and width of said surface.

13. The wrapping material of claim 12 wherein said multi-layered adhesive is disposed on the surface opposite of said surface having adhesive characteristics along the entire length and width of said surface.

14. The wrapping material of claim 6 wherein said second wrapping portion detaches from said first wrapping portion at the end of a wrapping cycle and said multi-layered adhesive releaseably attaches to a portion of said second wrapping portion so that the item is wrapped and said second releasable adhesive layer does not contact the item being wrapped.

15. The wrapping portion of claim 14 wherein said second wrapping portion has a upper surface and a lower surface and said multi-layered adhesive is disposed on said lower surface so that when the wrapping cycle is complete, the multi-layered adhesive releaseably attaches said lower surface to said upper surface.

16. The wrapping portion of claim 6 wherein said first adhesive layer and said second releasable adhesive layer remain adhered to said second wrapping portion at the end of a wrapping cycle.

17. The wrapping material of claim 6 wherein said first wrapping portion and said second wrapping portions have two opposing lateral ends and at least one of said two opposing lateral ends is tapered to guide the wrapping portions into a wrapping machine.

18. The wrapping material of claim 6 further including a metalized tag carried by an upper surface of one of said first wrapping portion and said second wrapping portion to instruct a wrapping machine when to cause a dispensing roll to dispense said second wrapping portion and when to cease dispensing said second wrapping portion.

19. A method of manufacturing a wrapping material comprising the steps of:
cutting a first wrapping portion and a second wrapping portion;
creating a U-shaped fold by folding a lateral end of said second wrapping portion back over the remainder of the second wrapping portion;
creating a multi-layered adhesive by applying a first adhesive layer to a portion of said lateral end of said second wrapping portion and applying a second releasable adhesive layer on top of said first adhesive layer;
creating a S-Shaped interlock by placing a lateral end of said first wrapping portion over the U-shaped fold so that said first wrapping portion covers the multi-layered adhesive and releaseably attaching said first wrapping portion to said multi-layered adhesive.

20. The method of manufacturing a wrapping material of claim 19 further comprising the step of providing one of the upper surface and lower surface of the wrapping portion with adhesive characteristics along the entire surface.
